(19) United States
(12) Patent Application Publication
(10) Pub. No.: US 2018/0159695 A1
(43) Pub. Date: Jun. 7, 2018

(54) START CONTROL DEVICE, INFORMATION PROCESSING SYSTEM AND NON-TRANSITORY COMPUTER-READABLE RECORDING MEDIUM STORING PROGRAM

(71) Applicant: Fujitsu Limited, Kawasaki-shi (JP)

(72) Inventor: Masato SEMII, Yokohama (JP)

(73) Assignee: Fujitsu Limited, Kawasaki-shi (JP)

(21) Appl. No.: 15/818,827

(22) Filed: Nov. 21, 2017

(30) Foreign Application Priority Data
Dec. 2, 2016 (JP) 2016-234889

(51) Int. Cl. H04L 12/12; G06F 9/44

(52) U.S. Cl. CPC H04L 12/12; H04L 12/28; G06F 9/4406; G06F 9/4418

(57) ABSTRACT

A start control device that starts an electronic apparatus, the start control device includes: a controller configured to start the electronic apparatus based on a start signal received from a network; and a plurality of receivers configured to receive the start signal from the network, wherein at least one of the plurality of receivers includes a storage that stores identification information of the at least one of the plurality of receivers and identification information of another receivers, and wherein the at least one of receivers receives the start signal and identification information of one of the plurality of receivers from the network and executes a process that instructs the controller to start the electronic apparatus when the received identification information matches the identification information of the another receiver stored in the storage.

### CROSS-REFERENCE TO RELATED APPLICATION

This application is based upon and claims the benefit of priority of the prior Japanese Patent Application No. 2016-234889, filed on Dec. 2, 2016, the entire contents of which are incorporated herein by reference.

### FIELD

The embodiments discussed herein are related to a start control device, an information processing system, and a non-transitory computer-readable recording medium storing a program that control start of an electronic apparatus.

### BACKGROUND

In an information processing system including a plurality of computers connected with each other by a network, a method of a Wake-On-LAN (WOL) starts each computer which is an electronic apparatus in the system. WOL is a mechanism that transmits a specific packet to a network and starts a computer specified by the contents of the specific packet. A packet which is a start signal transmitted in WOL is called a magic packet which is broadcasted to each computer in the network.

Related techniques are disclosed in, for example, Japanese Laid-Open Patent Publication No. 2005-020728.

### SUMMARY

A start control device that starts an electronic apparatus, the start control device includes: a controller configured to start the electronic apparatus based on a start signal received from a network; and a plurality of receivers configured to receive the start signal from the network, wherein at least one of the plurality of receivers includes a storage that stores identification information of the at least one of the plurality of receivers and identification information of another receivers, and wherein the at least one of receivers receives the start signal and identification information of one of the plurality of receivers from the network and executes a process that instructs the controller to start the electronic apparatus when the received identification information matches the identification information of the another receiver stored in the storage.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a schematic view illustrating an example of a configuration of a start control device according to one embodiment;

FIG. 2 is a schematic view illustrating an example of a table stored in a baseboard management controller (BMC) according to one embodiment;

FIG. 3 is a schematic view illustrating an example of a table stored in NIC-A according to one embodiment;

FIG. 4 is a schematic view illustrating an example of a table stored in NIC-B according to one embodiment.

FIG. 5 is a flowchart of a process executed in the BMC according to one embodiment;

FIG. 6 is a flowchart of a process executed when NIC-A or NIC-B according to one embodiment is a specific NIC; and

FIG. 7 is a flowchart of a process executed in NIC-A or NIC-B according to one embodiment.

### DESCRIPTION OF EMBODIMENTS

For example, a magic packet including a virtual media access control (MAC) address is transmitted to a network interface card (NIC) in a partition including a plurality of virtual machines and the virtual machines in the partition are started by WOL.

If any one of receivers that receives a start signal from a network has failed, the failed receiver may not be able to properly process the start signal, and the corresponding electronic apparatus may not be started. For example, when a magic packet in which a MAC address of one of NICs in a computer is specified is transmitted, if the corresponding NIC has failed, the NIC may not process the magic packet properly, and the computer may not be started.

In view of the above, it may be provided a start control device capable of starting an electronic apparatus even when a receiver that receives a start signal from a network fails.

Hereinafter, embodiments of the present disclosure will be described with reference to the accompanying drawings. It is to be noted that the following detailed description is only illustrative but is not intended to limit a configuration of the embodiments.

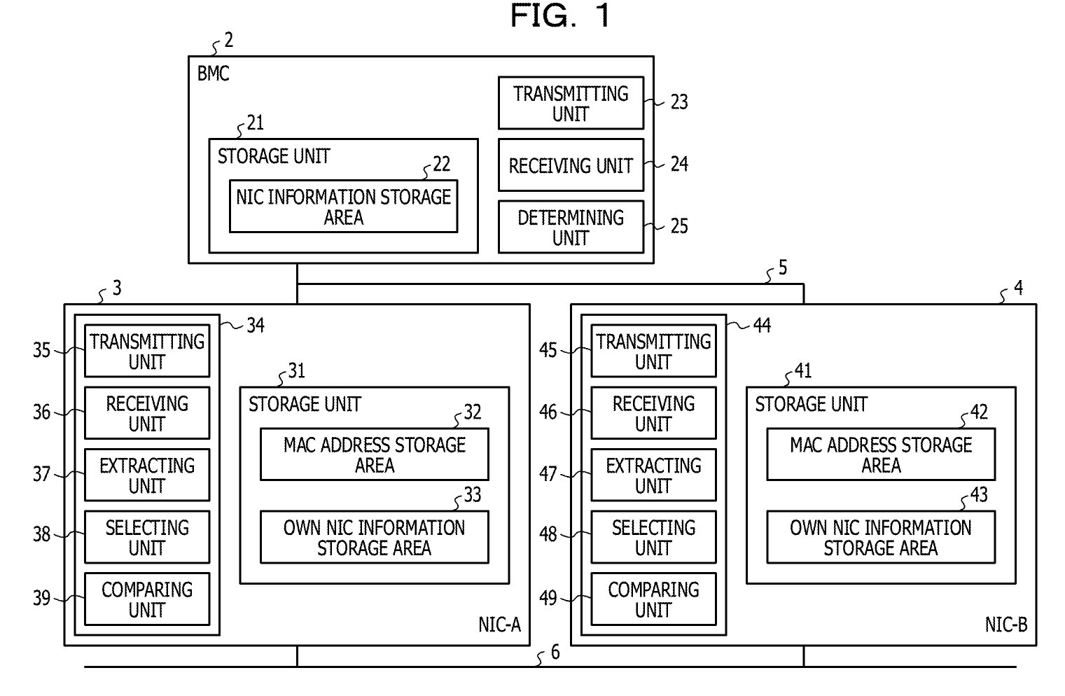

FIG. 1 is a schematic view illustrating an example of a configuration of a start control device 1 according to one embodiment. The start control device 1 includes a baseboard management controller (BMC) 2, a network interface card (NIC)-A 3, and a network interface card (NIC)-B 4. In the present embodiment, as an example, the NIC-A 3 and the NIC-B 4 may be interconnected to the BMC 2 via a serial bus 5 such as an I2C bus or a system management (SM) bus. As another example, the NIC-A 3 and the NIC-B 4 may be coupled to an external device of the start control device 1 via a local area network (LAN) cable 6.

The BMC 2 includes a storage unit 21 such as a flash electrically erasable programmable read-only memory (EEPROM). The storage unit 21 has an NIC information storage area 22. Further, the BMC 2 includes a transmitting unit 23, a receiving unit 24, and a determining unit 25. The BMC 2 executes processes of each unit of the transmitting unit 23, the receiving unit 24, and the determining unit 25 by developing and executing programs stored in the storage unit 21, which will be described in detail later. Here, the BMC 2 is an example of a starting unit that starts an information processing apparatus. Further, the storage unit 21 is an example of a storage unit that stores identification information which identifies a receiving unit in advance.

The NIC-A 3 includes a storage unit 31 such as a flash EEPROM. The storage unit 31 has an MAC address storage area 32 and its own NIC information storage area 33. The NIC-A 3 further includes a control unit 34 such as a chip set. By executing programs stored in the storage unit 31, the control unit 34 executes processes of each unit of a transmitting unit 35, a receiving unit 36, an extracting unit 37, a selecting unit 38, and a comparing unit 39. The NIC-B 4 includes components corresponding to the NIC-A 3, for example, a storage unit 41, an MAC address storage area 42, an own NIC information storage area 43, a control unit 44, a transmitting unit 45, a receiving unit 46, an extracting unit 47, a selecting unit 48, and a comparing unit 49. Details of the processes of each unit of the NIC-A 3 and NIC-B 4 will be described later. Here, the NIC-A 3 and the NIC-B 4 are one example of a plurality of receiving units that receive a start signal from a network.

Next, processes executed by the BMC 2, the NIC-A 3, and the NIC-B 4 of the start control device 1 will be described below with reference to the drawings. In the present embodiment, each of the NIC-A 3 and the NIC-B 4 receives a magic packet that starts a server including the start control device 1 from an external device via the LAN cable 6. As an example, the magic packet is a packet having a payload containing a data pattern (AMD Magic Packet Format) in which the MAC address of the NIC-A 3 or NIC-B 4 is repeated 16 times following FF:FF:FF:FF:FF:FF.

In the present embodiment, upon receiving a magic packet in which a MAC address of the NIC-A 3 is specified, the NIC-A 3 asserts a signal line to start a server provided with the start control device 1, among signal lines coupled to the BMC 2. As used herein, the term “assert” means, for example, enabling an instruction signal of a signal line. Furthermore, the NIC-A 3 asserts the signal line even when it receives a magic packet in which a MAC address of the NIC-B 4 is specified. For example, even when the NIC-A 3 receives a magic packet in which a MAC address of NIC other than its own NIC is specified, the NIC-A 3 asserts the signal line. Similarly, when the NIC-B 4 receives a magic packet in which a MAC address of NIC other than its own NIC is specified, the NIC-B 4 asserts a signal line that starts a server provided with the start control device 1, among the signal lines coupled to the BMC 2.

In the present embodiment, when both of the NIC-A 3 and the NIC-B 4 assert the respective signal lines, upon detecting the assertion of one of the signal lines, the BMC 2 ignores the assertion of the other of the signal lines. Details of the processes executed when the NIC-A 3 and the NIC-B 4 assert the signal line will be described below.

In the following description, what correspondence propriety information of NIC indicates that it is applicable means that a signal line which starts a server is asserted even when the NIC receives a magic packet in which a MAC address of NIC other than its own NIC is specified. In addition, what the correspondence propriety information of NIC indicates that it is not applicable means that, upon receiving a magic packet in which a MAC address of NIC other than its own NIC is specified, the NIC discards the received packet and does not assert a signal line that starts a server similarly to the NIC in the related art. The NIC-A 3 and the NIC-B 4 store the correspondence propriety information in advance in their own NIC information storage areas 33 and 43 of the storage units 31 and 41, respectively. As one example, when the correspondence propriety information is a 1-bit flag of a register, the correspondence propriety information, in a case where the flag is “1”, indicates that it is applicable and the correspondence propriety information, in a case where the flag is “0”, indicates that it is not applicable. In addition, the NIC-A 3 and NIC-B 4 store the MAC addresses of their own NICs in advance in their own NIC information storage areas 33 and 43, respectively. Here, the MAC addresses of the NIC-A 3 and NIC-B 4 are examples of identification information that identifies a receiving unit.

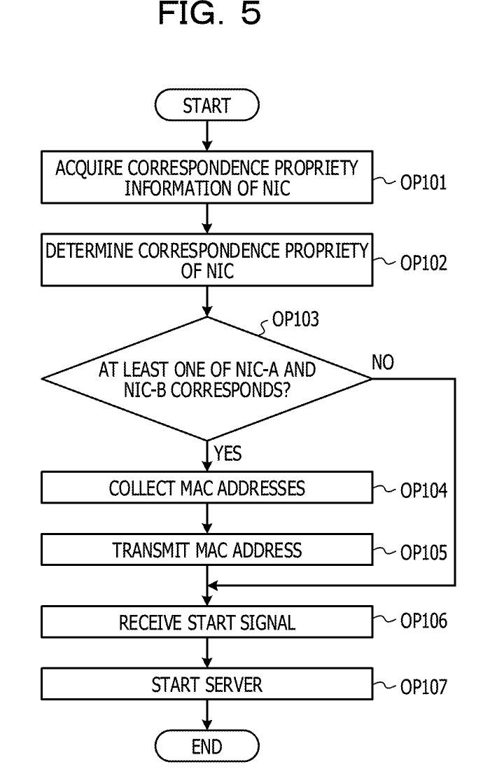

FIG. 5 illustrates an example of a flowchart of a process executed by the BMC 2. When the power state of a server becomes an alternate current (AC) power supply state, the BMC 2 starts the process of the flowchart illustrated in FIG. 5. What the power state of the server is the AC power supply state indicates that the operating system (OS) of the server is not in operation, for example, in a standby state. In OP101, the transmitting unit 23 of the BMC 2 transmits a request for correspondence propriety information to the NIC-A 3 and the NIC-B 4. Upon receiving the request, the receiving units 36 and 46 of the NIC-A 3 and NIC-B 4 acquire the correspondence propriety information from their own NIC information storage areas 33 and 43 of the storage units 31 and 41, respectively. The transmitting units 35 and 45 of the NIC-A 3 and NIC-B 4 then transmit the acquired correspondence propriety information to the BMC 2. The receiving unit 24 of the BMC 2 receives the correspondence propriety information from the NIC-A 3 and the NIC-B 4. The BMC 2 stores the received correspondence propriety information in the NIC information storage area 22.

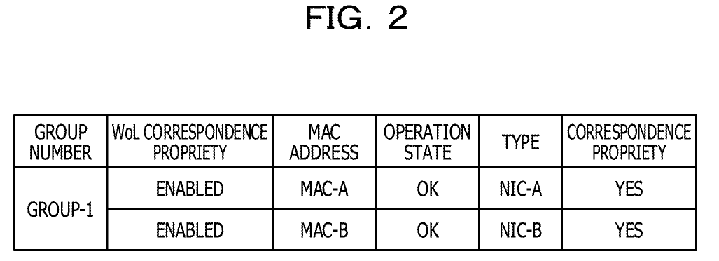

FIG. 2 illustrates an example of a table stored in the NIC information storage area 22. As illustrated in FIG. 2, a group (“group number”) to which each NIC in the start control device 1 belongs and information (“WoL correspondence propriety”) indicating whether or not each NIC corresponds to WoL are stored in the NIC information storage area 22. Further, an MAC address of each NIC (“MAC address”), an operation state of each NIC (“operation state”), identification information (“type”) of each NIC and information (“correspondence propriety”) indicating whether the correspondence propriety information corresponds to being-applicable or not are stored in the NIC information storage area 22. The correspondence propriety information acquired in OP101 is stored in the “correspondence propriety” of the table. Note that the BMC 2 may acquire the information of each of items of the “group number”, “WoL correspondence propriety”, “operation state”, and “type”, together with the correspondence propriety information, from each NIC in OP101 or before starting the process of the flowchart.

Next, in OP102, the determining unit 25 of the BMC 2 determines whether the correspondence propriety information stored in the NIC information storage area 22 indicates correspondence or non-correspondence. When it is determined that at least one of the correspondence propriety information of the NIC-A 3 and the correspondence propriety information of NIC-B 4 stored in the NIC information storage area 22 indicates correspondence (“Yes” in OP103), the BMC 2 advances the process to OP104. When both of the correspondence propriety information of the NIC-A 3 and the correspondence propriety information of the NIC-B 4 stored in the NIC information storage area 22 indicates non-correspondence (“No” in OP103), the BMC 2 advances the process to OP106.

In OP104, the transmitting unit 23 of the BMC 2 collects an MAC address of each NIC from the NIC-A 3 and the NIC-B 4. For example, the transmitting unit 23 transmits a request for transmission of an MAC address of each NIC to the BMC 2 to the NIC-A 3 and the NIC-B 4. Upon receiving the request, the receiving units 36 and 46 of the NIC-A 3 and the NIC-B 4 acquire the MAC addresses of their own NICs from their own NIC information storage areas 33 and 43 of the storage units 31 and 41, respectively. The transmitting units 35 and 45 of the NIC-A 3 and NIC-B 4 transmit the acquired MAC addresses to the BMC 2. The receiving unit 24 of the BMC 2 receives the MAC addresses from the NIC-A 3 and the NIC-B 4. The BMC 2 stores the received MAC addresses in the “MAC address” of the above-described table of the NIC information storage area 22.

In OP105, the transmitting unit 23 of the BMC 2 transmits the MAC addresses stored in the NIC information storage area 22 to the NIC-A 3 and the NIC-B 4. In the present embodiment, each of the MAC addresses of the NIC-A 3 and NIC-B 4 is stored in the NIC information storage area 22. Therefore, the BMC 2 transmits the MAC addresses of the NIC-A 3 and NIC-B 4 to the NIC-A 3 and the NIC-B 4, respectively. The MAC address of the NIC-A 3 is transmitted to the NIC-A 3 so that the MAC address of the NIC-A 3 is written in the MAC address storage area 32 different from its own NIC information storage area 33. The same is applied to the NIC-B 4.

The receiving units 36 and 46 of the NIC-A 3 and NIC-B 4 receive the MAC addresses of the NIC-A 3 and NIC-B 4 from the BMC 2. The NIC-A 3 and the NIC-B 4 write the received MAC addresses of the NIC-A 3 and NIC-B 4 in the MAC address storage areas 32 and 42, respectively. Further, upon completing the writing of the MAC addresses in the MAC address storage areas 32 and 42, the NIC-A 3 and the NIC-B 4 set flags indicating that the writing is completed in the storage units 31 and 41, respectively.

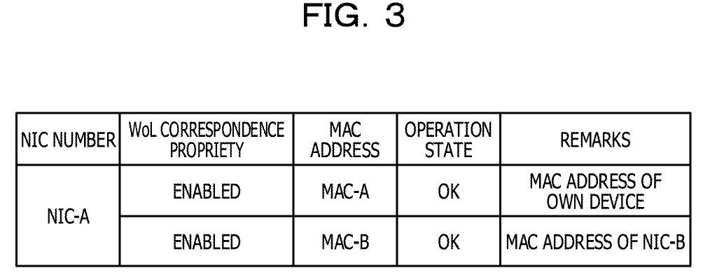

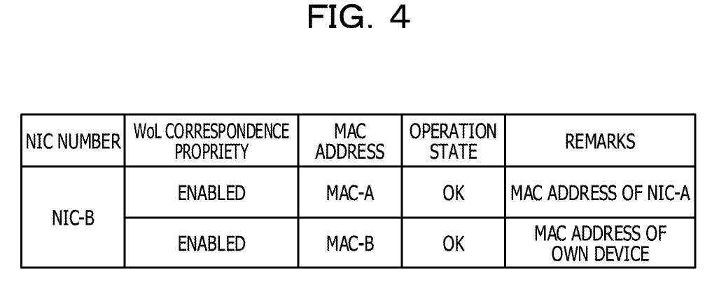

Here, FIG. 3 illustrates an example of a table stored in the MAC address storage area 32 of the storage unit 31 of the NIC-A 3. Further, FIG. 4 illustrates an example of a table stored in the MAC address storage area 42 of the storage unit 41 of the NIC-B 4. As illustrated in FIGS. 3 and 4, identification information of its own NIC (“NIC number”) and information (“WoL correspondence propriety”) indicating whether or not each NIC corresponds to WoL are stored in the MAC address storage areas 32 and 42. Further, an MAC address of each NIC (“MAC address”), an operation state of each NIC (“operation state”), and additional information of each NIC (“remarks”) are stored in the MAC address storage areas 32 and 42. In OP105, the NIC-A 3 and the NIC-B 4 store the MAC address received from the BMC 2 in the “MAC address” of the MAC address storage areas 32 and 42, respectively.

In OP106, the receiving unit 24 of the BMC 2 receives a start signal from the NIC-A 3 and/or the NIC-B 4. Further, details of a process by the NIC-A 3 and NIC-B 4 of transmitting the start signal to the BMC 2 will be described later. Upon receiving the start signal, the BMC 2 starts a server provided with the start control device 1 (OP107).

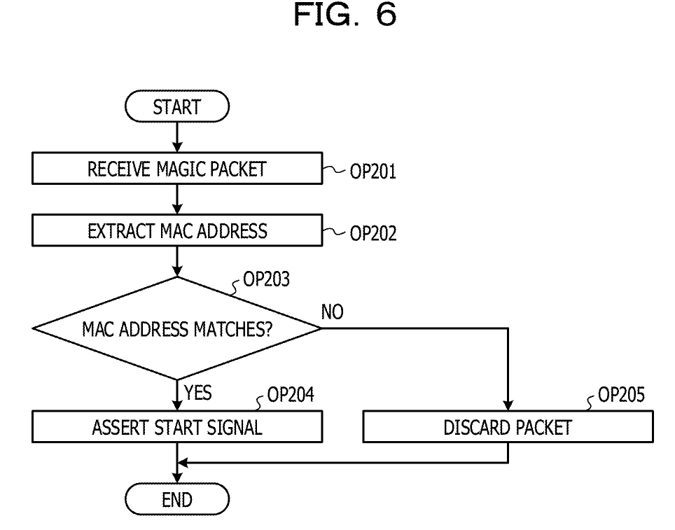

Next, FIG. 6 illustrates an example of a flowchart of a process executed by the NIC indicating that correspondence propriety information is non-correspondence in the start control device 1 of the present embodiment. In the following description, it is assumed that the correspondence propriety information of the NIC-A 3 indicates a non-correspondence. In this case, the NIC-A 3 does not include the MAC address storage area 32 and the selecting unit 38. Other configurations are substantially the same as those illustrated in FIG. 1. Then, the NIC-A 3 may perform substantially the same process as the NIC in the related art. For example, even upon receiving a magic packet in which a MAC address of NIC other than its own NIC is specified, the NIC-A 3 does not assert a signal line that starts a server provided with the start control device 1, among the signal lines coupled to the BMC 2. Further, when the power state of the server becomes an AC power supply state, the control unit 34 of the NIC-A 3 starts the process of the flowchart illustrated in FIG. 5.

In OP201, the receiving unit 36 of the NIC-A 3 receives a magic packet broadcasted from an external device of the server provided with the start control device 1 via the LAN cable 6. Next, in OP202, the extracting unit 37 of the NIC-A 3 extracts an MAC address from the received magic packet.

Then, in OP203, the comparing unit 39 of the NIC-A 3 compares the MAC address extracted in OP202 with the MAC address stored in its own NIC information storage area 33. When it is determined that the MAC address extracted in OP202 matches the MAC address stored in its own NIC information storage area 33 (“Yes” in OP203), the control unit 34 advances the process to OP204. In the meantime, when it is determined that the MAC address extracted in OP202 does not match the MAC address stored in its own NIC information storage area 33 (“No” in OP203), the control unit 34 advances the process to OP205.

In OP204, the control unit 34 asserts a signal line that starts a server provided with the start control device 1, among the signal lines coupled to the BMC 2. The BMC 2 starts the server when the signal line is asserted. In OP205, the control unit 34 also discards the magic packet received in OP201 and ends the process of this flowchart. As a result, the control unit 34 does not assert the signal line that starts the server provided with the start control device 1.

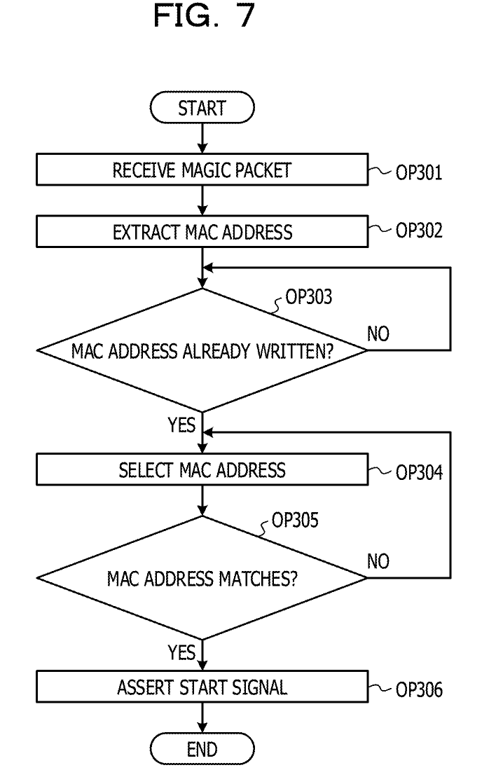

Next, FIG. 7 illustrates an example of a flowchart of a process executed by the NIC indicating that correspondence propriety information indicates correspondence in the start control device 1 of the present embodiment. In the following description, a case where the correspondence propriety information of the NIC-A 3 indicates correspondence and the control unit 34 executes the process of the flowchart illustrated in FIG. 7 will be described. Further, this is equally applied to the process executed by the control unit 44 when the correspondence propriety information of the NIC-B 4 indicates correspondence. When the power state of a server becomes an AC power supply state, the control unit 34 of the NIC-A 3 starts the process of the flowchart illustrated in FIG. 5.

In OP301, the receiving unit 36 of the NIC-A 3 receives a magic packet broadcasted from an external device of the server provided with the start control device 1 via the LAN cable 6. Next, in OP302, the extracting unit 37 of the NIC-A 3 extracts an MAC address from the received magic packet. Then, in OP303, the control unit 34 of the NIC-A 3 determines whether or not an MAC address has already been written in the MAC address storage area 32 of the storage unit 31.

The control unit 34 refers to the flag of the storage unit 31 described in the above-described process of OP105 to determine whether or not the MAC address has already been written in the MAC address storage area 32. When it is determined that the MAC address has already been written in the MAC address storage area 32 (“Yes” in OP303), the control unit 34 advances the process to OP304. In the meantime, when it is determined that the writing of the MAC address in the MAC address storage area 32 has not been completed (“No” in OP303), the control unit 34 repeats the determination process of OP303.

In OP304, the selecting unit 38 selects one of MAC addresses written in the MAC address storage area 32. Then, in OP305, the comparing unit 39 determines whether or not the selected MAC address matches the MAC address extracted in OP302. When it is determined that the selected MAC address matches the MAC address extracted in OP302 (“Yes” in OP305), the control unit 34 advances the process to OP306. When it is determined that the selected MAC address does not match the MAC address extracted in OP302 (“No” in OP305), the control unit 34 returns the process to OP304.

When the control unit 34 returns the process from OP305 to OP304, the selecting unit 38 selects an MAC address other than the already selected MAC address from the MAC address storage area 32 in OP304. As a result, the MAC address extracted in OP302 is compared with the MAC addresses written in the MAC address storage area 32 one by one to determine whether or not the MAC address extracted in OP302 matches the MAC addresses written in the MAC address storage area 32.

In OP306, the control unit 34 asserts a signal line that starts a server provided with the start control device 1, among the signal lines coupled to the BMC 2. The BMC 2 starts the server when the signal line is asserted.

As described above, according to the present embodiment, in the case where the correspondence propriety information of the NIC-A 3 indicates correspondence, the MAC address of the NIC-B 4 is written in the MAC address storage area 32. Therefore, when the NIC-A 3 receives a magic packet in which a MAC address of the NIC-B 4 is specified, it is determined that the MAC address of the NIC-B 4 extracted from the magic packet matches the MAC address of the NIC-B 4 written in the MAC address storage area 32 (OP305). As a result, the signal line that starts the server provided with the start control device 1 is asserted by the NIC-A 3 and the server is started by the BMC 2 (OP306).

Therefore, in the event of failure of the NIC-B 4, even when a magic packet in which a MAC address of the NIC-B 4 is specified is broadcasted via the LAN cable 6, the server is started. That is, the external device of the server provided with the start control device 1 may start the server without retransmitting the magic packet in which the MAC address of the NIC-B 4 is specified or without separately transmitting a magic packet in which a MAC address of the NIC-A 3 is specified.

The present embodiment has been described above. However, the above-described configurations and processes of the server and the like are not limited to the above-described embodiment, but various modifications may be made within the scope which does not depart from the technical spirit of the present disclosure. For example, in the above embodiment, the information of the tables stored in the NIC information storage area 22 of the BMC 2, the MAC address storage area 32 of the NIC-A 3, and the MAC address storage area 42 of the NIC-B 4 are not limited to those shown in FIGS. 2, 3 and 4. In the case of the above embodiment, the BMC 2 may hold the MAC addresses of the NIC-A 3 and NIC-B 4, the NIC-A 3 may hold the MAC addresses of its own NIC and the NIC-B 4, and the NIC-B 4 may hold the MAC addresses of its own NIC and the NIC-A 3. Other information may be set to be stored in the NIC information storage area 22 and the MAC address storage areas 32 and 42 as appropriate.

In the above embodiment, when the server provided with the start control device 1 is in the AC power supply state, the BMC 2, the NIC-A 3, and the NIC-B 4 start the processes of the flowcharts of FIGS. 5, 6, and 7. However, the operations of the BMC 2, the NIC-A 3, and the NIC-B 4 may be set so as to start the processes of the flowcharts of FIGS. 5, 6, and 7 at other arbitrary timings. For example, when the NIC-A 3 and the NIC-B 4 are PCI Express (PCIe) cards, card exchanging is performed and the BMC 2 detects an exchanged card, the BMC 2 may start the process of the flowchart of FIG. 5.

Further, the MAC addresses stored in the MAC address storage areas 32 and 42 of the NIC-A 3 and NIC-B 4 in OP105 of the above embodiment may be erased with lapse of a certain period of time. Further, it has been described in the above embodiment that the server is started by the start control device 1. However, without being limited to the above-mentioned server, the start control device 1 may be applied to any other type of electronic apparatuses such as a personal computer (PC) having substantially the same hardware configuration as the server.

In the above embodiment, the above-described at least portion of the process may be executed by a processor other than the CPU, for example, a dedicated processor such as a digital signal processor (DSP), a graphics processing unit (GPU), a numerical arithmetic processor, a vector processor, or an image processor. Further, the above-described at least portion of the process may be executed by an integrated circuit (IC) or other digital circuits. Further, an analog circuit may be included in at least a portion of each of the above-described components. The integrated circuit includes a large scale integration (LSI), an application specific integrated circuit (ASIC), and a programmable logic device (PLD). The PLD includes, for example, a field-programmable gate array (FPGA). Each of the above-described components may be a combination of a processor and an integrated circuit. The combination is called, for example, a microcontroller (MCU), a system-on-a-chip (SoC), a system LSI, a chip set, or the like.

<Computer-Readable Recording Medium>

Programs for implementing a management tool, an OS, and the like for setting the start control device in a computer, another machine, or a device (hereinafter, computer or the like) may be recorded on a recording medium readable by a computer or the like. Then, the programs of this recording medium may be read and executed in the computer or the like in order to provide the functions thereof.

Here, a recording medium readable by a computer or the like refers to a recording medium which may accumulate information such as data or programs by electrical, magnetic, optical, mechanical, or chemical actions and may read the information from a computer or the like. Among such recording media, those removable from a computer or the like include, for example, a flexible disk, a magneto-optical disk, a CD-ROM, a CD-R/W, a DVD, a Blu-ray disk, a DAT, an 8 mm tape, and a memory card such as a flash memory. Further, examples of a recording medium fixedly installed in a computer or the like may include a hard disk, a ROM, and the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A start control device that starts an electronic apparatus, the start control device comprising:
a controller configured to start the electronic apparatus based on a start signal received from a network; and
a plurality of receivers configured to receive the start signal from the network,
wherein at least one of the plurality of receivers includes a storage that stores identification information of the at least one of the plurality of receivers and identification information of another receivers, and
wherein the at least one of receivers receives the start signal and identification information of one of the plurality of receivers from the network and executes a process that instructs the controller to start the electronic apparatus when the received identification information matches the identification information of the another receiver stored in the storage.

2. The start control device according to claim 1, wherein the controller causes the at least one of receivers to store the identification information of the another receiver in the storage.

3. The start control device according to claim 2, wherein the controller determines whether or not the process is capable of being executed for each of the plurality of receivers, and stores the identification information of the another receiver in a storage of the receiving unit determined to be capable of executing the process.

4. An information processing system comprising:
an electronic apparatus; and
a start control device configured to start the electronic apparatus and including:
a controller that starts the electronic apparatus; and
a plurality of receivers that receive the start signal from a network,
wherein at least one of the plurality of receivers includes a storage that stores identification information of the at least one of the plurality of receivers and identification information of another receiver, and
wherein the at least one of receivers receives the start signal and identification information of one of the plurality of receivers from the network and executes a process that instructs the controller to start the electronic apparatus when the received identification information matches the identification information of the another receiver stored in the storage.

5. The information processing system according to claim 4, wherein the controller causes the at least one of receivers to store the identification information of the another receiver in the storage.

6. The information processing system according to claim 5, wherein the controller determines whether or not the process is executed for each of the plurality of receivers, and stores the identification information of the another receiver in a storage of the receiver determined to be capable of executing the process.

7. A non-transitory computer-readable recording medium storing a program that causes a computer to execute a process of:
causing a plurality of receivers to receive a start signal and identification information of one of the plurality of receivers from a network; and
instructing at least one of the plurality of receivers, which includes a storage configured to store identification information of the at least one of the plurality of receivers and identification information of another receiver, to start an electronic apparatus when the received identification information matches the identification information of the another receiver stored in the storage.

8. The non-transitory computer-readable recording medium according to claim 7, wherein the process further comprising causing the computer to execute a process of causing the at least one of receivers to store the identification information of the another receiver in the storage.

9. The non-transitory computer-readable recording medium according to claim 8, wherein the process further comprising causing the computer to execute a process of determining whether or not the process is capable of being executed for each of the plurality of receivers and storing the identification information of the another receiver in a storage of the receiver determined to be capable of executing the process.
